(19) United States
(12) Patent Application Publication
(10) Pub. No.: US 2009/0056871 A1
(43) Pub. Date: Mar. 5, 2009

(54) METHOD FOR PRODUCING STEEL COMPONENT INTEGRALLY HAVING RUBBER PORTION

(75) Inventors: Tomoaki NISHIMURA, Fukushima-shi (JP); Yoshiyuki KANZAKI, Fukushima-shi (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/200,150

(22) Filed: Aug. 28, 2008

(30) Foreign Application Priority Data
Aug. 29, 2007 (JP) 2007-221955

(51) Int. Cl. B32B 7/10

(52) U.S. Cl. 156/310

(57) ABSTRACT

To provide a method for producing a steel component integrally having a rubber portion without necessity to remove by a lathe turning a film formed on the surface of a steel component by a chemical conversion treatment and without deterioration of water-resistant adhesive property and anti-corrosion property during production steps due to omission of the chemical conversion treatment, the method for producing a steel component integrally having a rubber portion includes the steps of subjecting a surface of a steel component to a chemical conversion treatment with iron phosphate as a ground treatment (step S3), partially coating an adhesive on a portion to which a rubber portion is to be bonded (step S4), and bonding the rubber portion via baking to the steel component (step S5).

### BACKGROUND OF THE INVENTION

1. Field of the Invention

The present invention relates to a method for producing a steel component integrally having a rubber portion, e.g., a seal integrated piston used for a hydraulically actuated clutch of an automatic transmission of a vehicle.

2. Description of the Conventional Art

A hydraulically actuated clutch of an automatic transmission of a vehicle uses a steel component integrally having a rubber portion, e.g., a seal integrated piston and a seal integrated canceller which integrally have seal members made of a rubber-like elastic material.

FIG. 3 is a one-side sectional view of a schematic constitution of this kind of the hydraulically actuated clutch, which is shown by cutting it along a plane passing through a shaft center 0 of a driving shaft. In FIG. 3, referential numeral 1 denotes an annular clutch cylinder which is rotated with a driving shaft (not illustrated). Referential numeral 2 denotes a seal integrated piston (also called as a bonded piston seal) which is provided movably in an axial direction in the clutch cylinder 1 so as to partition a hydraulic pressure chamber A between an inner end of the clutch cylinder 1 and itself. Referential numeral 3 denotes a seal integrated canceller (also called as a bonded canceller seal), in which an inner periphery thereof is locked at an inner peripheral portion of the clutch cylinder 1 via a stopper ring. The seal integrated canceller partitions a balanced oil chamber B in a space at the opposite side to the hydraulic pressure chamber A of the seal integrated piston 2. Referential numeral 4 donates a return spring which is provided in a proper compression state between the seal integrated piston 2 and the seal integrated canceller 3. Referential numeral 5 denotes a multiple disc clutch.

The seal integrated piston 2 has a seal lip 22 which is integrally bonded via baking (integrally formed) onto an outer peripheral cylinder portion 21e of a piston main body 21. The seal lip 22 is made of a rubber-like elastic material, and is slidably and tightly contacted with an inner surface of the clutch cylinder 1. The piston main body 21 is made by punching and pressing of a steel sheet. In the seal integrated piston 2, an inner peripheral surface of an inner peripheral cylinder portion 21a is slidably and tightly contacted with a seal ring 11 which is made of a rubber-like elastic material and is provided at an inner peripheral portion of the clutch cylinder 1. The seal integrated canceller 3 includes a seal lip 32 which is integrally bonded at an outer peripheral edge of a canceller main body 31, and is slidably and tightly contacted with an inner peripheral surface of the outer peripheral cylinder portion 21e of the piston main body 21. The canceller main body 31 is made by punching and pressing of a steel sheet. Further, an oil passage C to introduce control oil pressure to the hydraulic pressure chamber A and an oil passage D to supply operation oil to the balanced oil chamber B are provided at an inner peripheral portion of the clutch cylinder 1.

In the hydraulically actuated clutch, when control oil pressure is applied to the hydraulic pressure chamber A through the oil passage C, the seal integrated piston 2 is displaced in a direction to compress the return spring 4, and then a drive plate 51 and a driven plate 52 in the multiple disc clutch 5 are pressed so as to be frictionally engaged. Therefore, the multiple disc clutch 5 is made to be in the connecting state, and a drive torque of the driving shaft (not illustrated) is transmitted to a driven shaft (not illustrated) from the clutch cylinder 1 through the multiple disc clutch 5 and a clutch hub 6.

Further, when the control oil pressure in the hydraulic pressure chamber A is released in the connecting state of the multiple disc clutch 5, the seal integrated piston 2 moves to return in the direction to reduce the volume of the hydraulic pressure chamber A by returning force of the compressed return spring 4. Thereby, the frictionally engaging state between the drive plate 51 and the driven plate 52 in the multiple disc clutch 5 is released, and then transmitting of driving force from the driving shaft to the driven shaft is cut off. At this time, centrifugal hydraulic pressure generated in the hydraulic pressure chamber A and the centrifugal hydraulic pressure generated in the balanced oil chamber B are approximately balanced at the both sides in the axial direction of the seal integrated piston 2. Thus, returning movement of the seal integrated piston 2 is done smoothly.

In the above-described constitution, the seal integrated piston 2 and the seal integrated canceller 3 are conventionally produced by a process shown in FIG. 4. That is, a steel ring (a piston main body 21 or a canceller main body 31) is made by punching and pressing of a steel sheet in step S101. The steel ring is degreased and washed in next step S102, is subjected to a chemical conversion treatment by fully dipping it in a zinc phosphate solution in order to secure water-resistant adhesive property in step S103, and coated with an adhesive by fully dipping in step S104. Thereafter, the steel ring is set in a metal mold and a rubber portion (a seal lip) is bonded thereon via baking in step S105. Portions to be sliding surfaces (e.g., in a case of the seal integrated piston 2 in FIG. 3, an inner peripheral surface of the outer peripheral cylinder portion 21e on which the seal lip 32 slides, and an inner peripheral surface of the inner peripheral cylinder portion 21a on which the seal ring 11 slides) are machined by a lathe turning in step S106. The product is washed and subjected to an anti-corrosion treatment in step S107, and then is checked and shipped.

According to the above-described conventional producing method, the sliding surfaces are machined by to a lathe turning in step S106. The reason for this machining is as follows. When the steel ring is subjected to a chemical conversion treatment by fully dipping it in a zinc phosphate solution (in step S103), a film of zinc phosphate having the thickness of several μm is formed on the surface of the steel ring. Since this film has crystalline, it is necessary to prevent increasing of frictional resistance due to increased surface roughness and varying of frictional resistance due to unevenness of an overcoated adhesive on this film by fully dipping. Therefore, the number of steps is increased. Further, since a treatment to remove the film of zinc phosphate by the lathe turning is carried out after the rubber portion (seal lip) has been bonded via baking, it is necessary to sufficiently take care not to damage the rubber portion. Further, it is necessary to finish the sliding surfaces to be as smooth as possible in order to decrease the surface roughness. Furthermore, the washing step to remove chips generated by the lathe turning is necessary (in step S107). Thus, there is a problem that production cost is increased.

Further, Unexamined Japanese Patent Publication No. 2006-29373 discloses a production method to solve the above-described problems. In this method, the chemical conversion treatment with zinc phosphate in step S103 is omitted. A primer is partially coated only on a portion to be a surface on which a rubber portion is bonded, an adhesive is partially overcoated on the primer coated portion, and a rubber portion (a seal lip) is bonded via baking to the adhesive overcoated portion.

However, according to this method, water-resistant adhesive property and anti-corrosion property during production steps may be decreased because a chemical conversion treatment is omitted. Further, it is necessary to partially coat a primer having water resistance as a ground processing in order to improve water-resistant adhesive property, and thus production cost is increased.

### SUMMARY OF THE INVENTION

The present invention is to solve the above-described problems, and an objective of the present invention is to provide a method for producing a steel component integrally having a rubber portion, in which removal by a lathe turning of a film formed on the surface of a steel component by a chemical conversion treatment is not necessary and in which deterioration of water-resistant adhesive property and anti-corrosion property during production steps due to omission of a chemical conversion treatment is prevented.

As for a means to effectively solve the above-described technical problems, a method for producing a steel component integrally having a rubber portion according to the present invention includes the steps of subjecting a surface of a steel component to a chemical conversion treatment with iron phosphate as a ground processing, then partially coating an adhesive on a portion to which a rubber portion is to be bonded, and bonding the rubber portion via baking to the steel component.

In this method, it is more preferable that the adhesive has water resistance. Further, the present invention is effective particularly when the steel component is a seal integrated piston or a seal integrated canceller used for a hydraulically actuated clutch.

In the present invention, when a surface of a steel component is subjected to the chemical conversion treatment with iron phosphate, an amorphous film (an amorphous film of iron phosphate) is formed on the surface of the steel component. The thickness of the film is remarkably thin of submicron order (1 μm or less). The coated film has proper anti-corrosion and water resistance, and also has proper adhesion with an adhesive to be overcoated.

According to the method for producing a steel component integrally having a rubber portion according to the present invention, water-resistant adhesive property of a rubber portion with respect to a steel component can be secured by a chemical conversion treatment, and a film of iron phosphate formed on the surface of the steel component is amorphous. Thus, even when the steel component has a sliding surface, frictional resistance of the sliding surface is not increased owing to the film of iron phosphate. Therefore, a lathe turning to remove the film after bonding via baking of a rubber portion is not necessary, and a washing process after the lathe turning is also not necessary. Thus, the steel component can be produced with low cost. Further, since the surface of the steel component is protected with the film of iron phosphate having anti-corrosion and water resistance, deterioration of water-resistant adhesive property and anti-corrosion can be prevented.

Further, for an adhesive to be overcoated on the film, an adhesive having water resistance is used. Therefore, excellent water-resistant adhesive property can be obtained, equally to the case that a primer having water resistance is partially coated and then an adhesive is partially coated.

Further, the present invention can be effectively used particularly in production of a seal integrated piston and a seal integrated canceller used for a hydraulically actuated clutch.

### BRIEF DESCRIPTION OF THE DRAWINGS

FIG. 1 is a one-side sectional view of a seal integrated piston to be produced by the method for producing a steel component integrally having a rubber portion according to the present invention, which is shown by cutting it along a plane passing through a shaft center.

FIG. 2 is a flowchart of a process for illustrating the method for producing a steel component integrally having a rubber portion according to the present invention.

FIG. 3 is a one-side sectional view of a schematic constitution of a hydraulically actuated clutch, which is shown by cutting it along a plane passing through a shaft center of a driving shaft.

FIG. 4 is a flowchart of a process for illustrating a conventional production method.

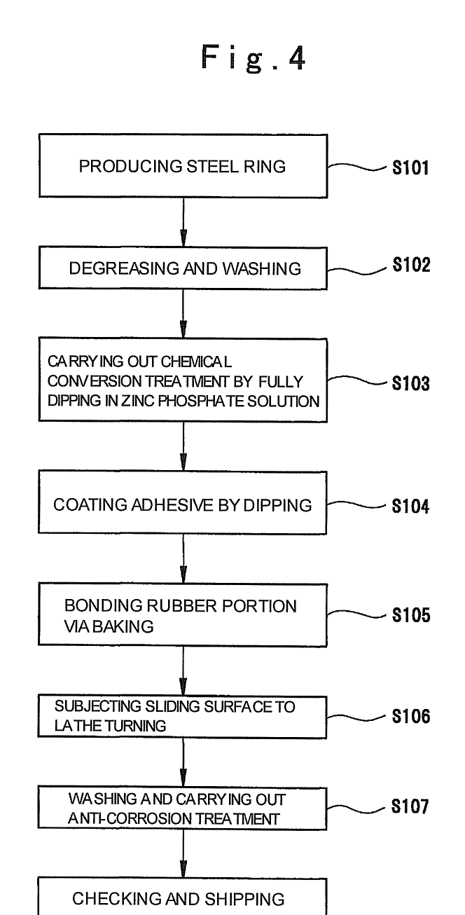

### DETAILED DESCRIPTION OF PREFERRED EMBODIMENT

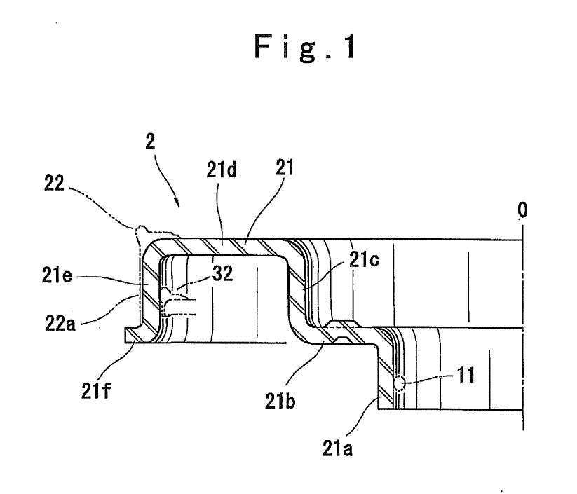

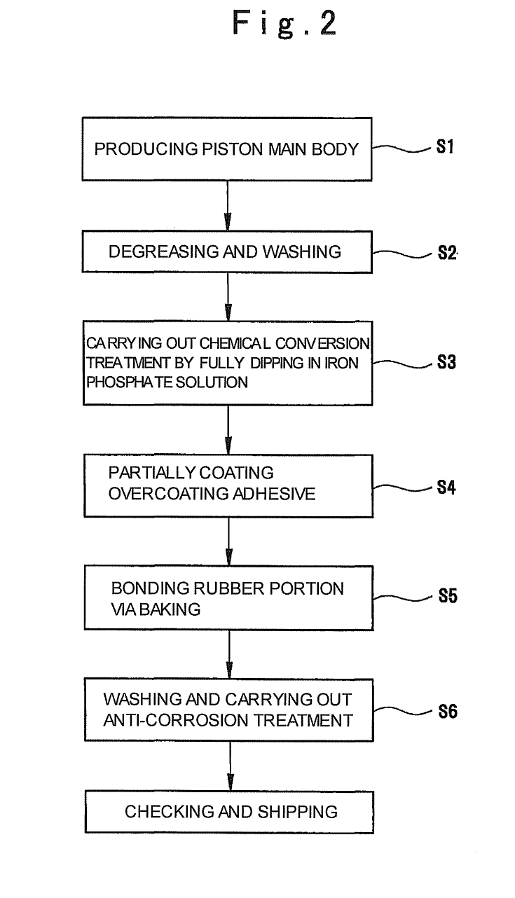

Preferred embodiments of the method for producing a steel component integrally having a rubber portion according to the present invention will be described below with reference to the drawings. FIG. 1 is a one-side sectional view of a seal integrated piston to be produced by the method for producing a steel component integrally having a rubber portion according to the present invention, which is shown by cutting it along a plane passing through a shaft center. FIG. 2 is a flowchart of a process for illustrating the method for producing a steel component integrally having a rubber portion according to the present invention.

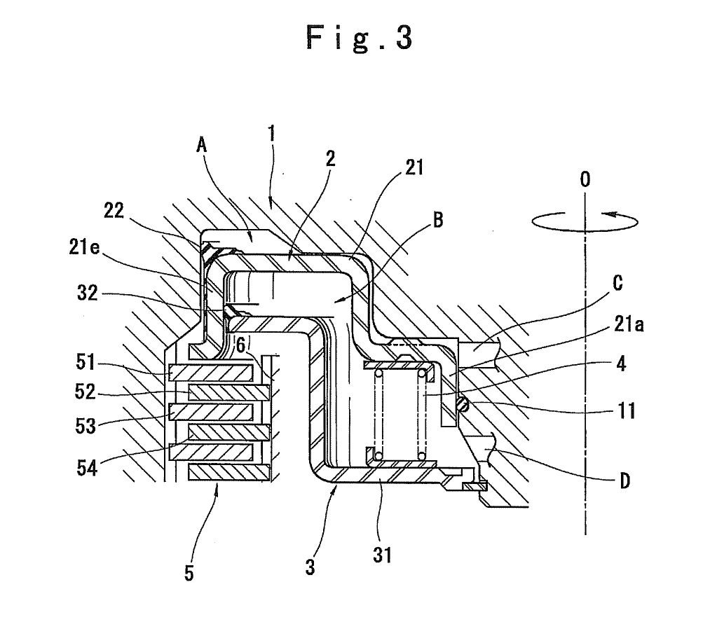

A seal integrated piston 2 shown in FIG. 1 corresponds to a steel component integrally having a rubber portion described in the second paragraph of Summary of the Invention and has a similar constitution to that illustrated in FIG. 3 which is described above. That is, the seal integrated piston 2 includes a piston main body 21 produced by punching and pressing or the like of a steel sheet and a seal lip 22 made of a rubber like-elastic material and integrally bonded to the piston main body 21 via baking.

More particularly, the piston main body 21 corresponds to a steel component described in the second paragraph of Summary of the Invention. The piston main body 21 includes an inner peripheral cylinder portion 21a, a spring receiving portion 21b, an intermediate cylinder portion 21c, an end plate portion 21d, an outer peripheral cylinder portion 21e, and a clutch pressing portion 21f. The inner peripheral cylinder portion 21a is slidable in the axial direction and tightly contacted with a seal ring 11, which is made of a rubber-like elastic material and provided at an inner peripheral portion of a clutch cylinder 1 illustrated in FIG. 3. The spring receiving portion 21b extends in the radial direction from an end portion at the hydraulic pressure chamber side of the inner peripheral cylinder portion 21a to hold one end of a return spring 4 illustrated in FIG. 3. The intermediate cylinder portion 21c extends concentrically from an outer peripheral end of the spring receiving portion 21b toward the opposite side to the inner peripheral cylinder portion 21a. The end plate portion 21d extends in the radial direction from an end portion at the hydraulic pressure chamber side of the intermediate cylinder portion 21c. The outer peripheral cylinder portion 21e extends concentrically from an outer peripheral end of the end plate portion 21d so as to form an approximately U-shaped cross-section together with the intermediate cylinder portion 21c. The clutch pressing portion 21f is formed at an end portion of the outer peripheral cylinder portion 21e.

The seal lip 22 made of a rubber-like elastic material is provided to be positioned at a bent portion between the end plate portion 21d and the outer peripheral cylinder portion 21e in the piston main body 21. A base portion and a rubber film portion 22a extended from the base portion of the seal lip 22 are bonded via baking so as to cover the whole outer peripheral surface of the outer peripheral cylinder portion 21e and the outer peripheral portion of the end plate portion 21d. In addition, the seal lip 22 and the rubber film portion 22a correspond to a rubber portion described in the paragraph of Summary of the Invention.

As illustrated in FIG. 2, to produce the seal integrated piston 2 illustrated in FIG. 1, the piston main body 21 is produced by punching and pressing or the like of a steel sheet in step 1, and then degreased and washed with an alkali degreasing agent in step S2.

Then, in step S3, the piston main body 21 is subjected to a chemical conversion treatment by fully dipping it in a treatment vessel, in which a treatment liquid consisting of an iron phosphate-based solution is filled, and dried so as to form an amorphous iron phosphate film on the whole surface thereof. In this case, as for an iron phosphate-based treating agent, PALFOS 1077 produced by Nihon Parkerizing Co., Ltd. or SURFTEX 6000 produced by Nippon Paint Co., Ltd., or the like can be used as it is. Water resistance and anti-corrosion property of the iron phosphate film is inferior to those of a zinc phosphate film. However, the iron phosphate film can fully achieve necessary water resistance and anti-corrosion property by general bonding via baking of rubber. Further, since the piston main body 21 is simply dipped in the treatment vessel, the treatment is easier than that by partial coating.

Further, in step S4, an overcoating adhesive for bonding a rubber via baking is partially coated on a surface to which a rubber portion (the seal lip 22 and the rubber film portion 22a) in the piston main body 21 is to be bonded, that is, on a region from the outer peripheral portion of the end plate portion 21d to the whole outer peripheral surface of the outer peripheral cylinder portion 21e. In this case, an adhesive having excellent water resistance is preferably selected. For example, a phenol resin-based adhesive consisting mainly of a novolak type phenol resin and/or a resol type phenol resin is preferable. More preferably, the phenol resin-based adhesive added with a metal oxide or a halogenated polymer or the like can be used.

In step S5, the piston main body 21 is set in a metal mold. Then, an unvulcanized rubber material is filled in a cavity formed between the piston main body 21 and an inner surface of the metal mold, and is heated and pressurized. Thereby, the rubber portion can be bonded via baking, that is, bonding via vulcanization is simultaneously carried out with forming via vulcanization. After the rubber portion is bonded via baking, the product is washed and subjected to an anti-corrosion treatment in step S6, and then is checked and shipped.

The seal integrated piston 2 of FIG. 1 produced by the above-described process is incorporated in a hydraulically actuated clutch as illustrated in FIG. 3 described above, and is reciprocated in the axial direction by applying and releasing of hydraulic pressure in the hydraulic pressure chamber A so as to make the multiple disc clutch 5 to be engaged and disengaged. Further, since the chemical conversion treatment in step S3 is carried out by fully dipping the piston main body 21, an iron phosphate film is formed by the chemical conversion treatment on an inner peripheral surface of the outer peripheral cylinder portion 21e on which a seal lip 32 of a seal integrated canceller 3 slides and an inner peripheral surface of the inner peripheral cylinder portion 21a on which a seal ring 11 at the clutch cylinder 1 side slides. However, the iron phosphate film is amorphous and has a remarkably thin thickness of submicron order (1 μm or less). Therefore, frictional resistance with respect to the seal lip 32 and the seal ring 11 is low, and wear of the seal lip 32 and the seal ring 11 can be inhibited.

Further, in the above-described production process, after the rubber portion is bonded via baking to the piston main body 21, it is not necessary to remove by a lathe turning, the iron phosphate film formed on the inner peripheral surfaces of the inner peripheral cylinder portion 21a and the outer peripheral cylinder portion 21e which are to be sliding surfaces. Furthermore, a washing step to remove chips generated by lathe turning is not necessary. As a result, a production cost can be reduced.

In addition, in the above-described embodiments, the present invention is applied to production of the seal integrated piston 2. However, the present invention can be also applied to production of the seal integrated canceller 3 illustrated in FIG. 3.

What is claimed is:

1. A method for producing a steel component integrally having a rubber portion, the method comprising:
subjecting a surface of a steel component to a chemical conversion treatment with iron phosphate as a ground processing;
partially coating an adhesive on a portion to which a rubber portion is to be bonded; and
bonding the rubber portion via baking to the steel component.

2. The method for producing a steel component integrally having a rubber portion as claimed in claim 1, wherein the adhesive has water resistance.

3. The method for producing a steel component integrally having a rubber portion as claimed in claim 1, wherein the steel component is a seal integrated piston or a seal integrated canceller used for a hydraulically actuated clutch.
